(19) United States
(12) Patent Application Publication
(10) Pub. No.: US 2026/0267042 A1
(43) Pub. Date: Sep. 10, 2026

(54) METAGRATING OUT-COUPLER AND ANTI-REFLECTIVE LAMINAE

(71) Applicant: Microsoft Technology Licensing, LLC, Redmond, WA (US)

(72) Inventors: Manisha SINGH, Espoo (FI); Mikhail ERDMANIS, Espoo (FI)

(73) Assignee: Microsoft Technology Licensing, LLC, Redmond, WA (US)

(21) Appl. No.: 19/071,285

(22) Filed: Mar. 5, 2025

(51) Int. Cl. G02B 5/18; G02B 27/00; G02B 27/01

(52) U.S. Cl. CPC G02B 5/1809; G02B 5/1857; G02B 27/0081; G02B 27/0172

(57) ABSTRACT

An optic comprises an optical waveguide, a series of anti-reflective laminae, and an exit grating. The waveguide supports total internal reflection of display light from the surface. The series of anti-reflective laminae are formed on the optical waveguide and arranged parallel to the surface. The exit grating is formed on the series of anti-reflective laminae. The exit grating includes a two-dimensional matrix of replicated, nanometer-scale features distributed parallel to the surface.

### BACKGROUND

Near-eye display technology has evolved in recent years to become an emerging consumer technology. In head-worn display devices, for example, binocular near-eye display provides 3D stereo vision for virtual-reality (VR) presentation. When implemented using see-through optics, near-eye display can provide mixed- or augmented-reality (AR) presentation, in which VR elements are admixed into the wearer's natural field of view. Despite such benefits, near-eye display technology faces various technical challenges. Such challenges include maintaining the appearance and transparency of normal eyewear.

### SUMMARY

One aspect of this disclosure relates to an optic comprising an optical waveguide, a series of anti-reflective laminae, and an exit grating. The waveguide supports total internal reflection of display light from a surface of the optical waveguide. The series of anti-reflective laminae are disposed on the optical waveguide and arranged parallel to the surface. The exit grating is disposed on the series of anti-reflective laminae and includes a two-dimensional matrix of replicated, nanometer-scale features distributed parallel to the surface.

Another aspect of this disclosure relates to a method for making an optic. The method comprises (a) applying a series of anti-reflective laminae to an optical waveguide, parallel to a surface of the optical waveguide; and (b) distributing a two-dimensional matrix of replicated, nanometer-scale features on the series of anti-reflective laminae, parallel to a surface of the optical waveguide. The optical waveguide supports total internal reflection of display light from the surface, and the matrix of replicated, nanometer-scale features comprises an exit grating.

Another aspect of this disclosure relates to a near-eye display device comprising a display projector and an expansion optic. The expansion optic is configured to receive a display image from the display projector and to release an expanded form of the display image. The expansion optic comprises (a) an optical waveguide having a surface and supporting total internal reflection of the display image from the surface; (b) a series of anti-reflective laminae disposed on the optical waveguide and arranged parallel to the surface; and (c) an exit grating disposed on the series of anti-reflective laminae. The exit grating includes a two-dimensional matrix of replicated, nanometer-scale features distributed parallel to the surface.

This Summary is provided to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any or all disadvantages noted in any part of this disclosure.

### BRIEF DESCRIPTION OF THE DRAWINGS

FIG. 1 shows aspects of an example near-eye display device.

FIG. 2 shows aspects of an example monocular system of a near-eye display device.

FIGS. 3A through 3D show aspects of an example expansion optic of a monocular system of a near-eye display device.

FIG. 4 shows aspects of an example expansion optic.

FIGS. 5A and 5B show aspects of an example exit grating of an optic.

FIG. 6 shows the wavelength dependence of R₁, T₁, and the branching ratio R₁/T₁, for set of linear slanted exit gratings of an optic.

FIGS. 7A through 7C show aspects of example optics each having an optical waveguide and a metagrating exit grating.

FIGS. 8A through 8E show data for example metagrating matrices that can be used in various regions of an exit grating of an optic.

FIG. 9 shows aspects of an example method for making an optic.

FIG. 10 shows aspects of an example optic having an optical waveguide, a metagrating exit grating, and a series of anti-reflective laminae arranged between the exit grating and the waveguide.

FIG. 11 shows aspects of another method for making an optic.

FIGS. 12A and 12B show aspects of stereoscopic display projection.

### DETAILED DESCRIPTION

Optical waveguides have various applications in modern optical engineering. In some applications, one or more diffraction gratings are arranged on one or both of the opposing surfaces of an optical waveguide. A diffraction grating may be used, for instance, to couple light into the optical waveguide or to release light from the optical waveguide. Conventional, linear diffraction gratings, comprising series of elongate, nanometer-scale grooves or ridges, may be used for these purposes. Linear diffraction gratings may not function ideally in every configuration and use scenario, however. For instance, a linear diffraction grating may leak a significant portion of out-coupled light 180° from the desired out-coupling direction. Furthermore, arrangement of a diffraction grating directly on an optical waveguide may be sub-optimal in configurations in which the waveguide-grating assembly is intended to be transparent perpendicular to the direction of propagation of the light through the optical waveguide.

In order to address these issues and provide further advantages, this disclosure introduces an optical waveguide in which a ‘metagrating’ provides the out-coupling function. A metagrating is a two-dimensional matrix of replicated, nanometer-scale features distributed parallel to the surface of the optical waveguide. It is found that a suitably configured metagrating is capable of maintaining high out-coupling efficiency while reducing the proportion of light released anti-parallel to the desired out-coupling direction. When used in near-eye display applications, the metagrating feature provides advantageous technical effects, such as reduced external glow of the waveguide/out-coupler assembly. Furthermore, it is found that by arranging a series of anti-reflective laminae between the optical waveguide and the metagrating, the entire assembly becomes more transparent from the point of view of the user. This feature provides the advantageous technical effect of improved real-world visibility in AR display applications.

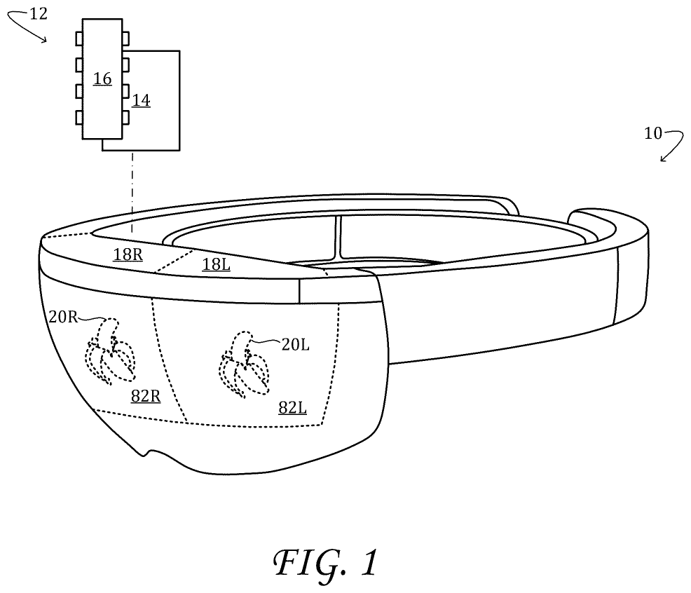

Turning now to the drawings, FIG. 1 shows aspects of an example near-eye display device 10. The near-eye display device is configured to be worn by a user and to display still or moving images in the user's field-of-view. In some examples, the near-eye display device may include or be part of an AR or VR display system that presents computer-generated, holographic imagery in the user's field-of-view. In some examples, user-input componentry of the AR or VR system may enable the user to interact with (e.g., manipulate) such imagery. To support any, some, or all of these functions, inter alia, near-eye display device 10 includes an onboard computer 12 having a processor 14 and associated computer memory 16. In the example illustrated in FIG. 1, near-eye display device 10 takes the form of a head-mounted visor. In other examples, a near-eye display device may take the form of goggles, a helmet, or eyeglasses. In still other examples, a near-eye display device may be a component of a non-wearable display system, such as a display system installed in a vehicle.

Near-eye display device 10 is configured for binocular image display. To that end, the near-eye display device includes a right monocular system 18R that presents a right display image 20R in front of the user's right eye, and a left monocular system 18L that presents a left display image 20L in front the user's left eye. For stereoscopic display the right and left display images may be configured with stereo disparity (vide infra) appropriate to display a three-dimensional subject or scene.

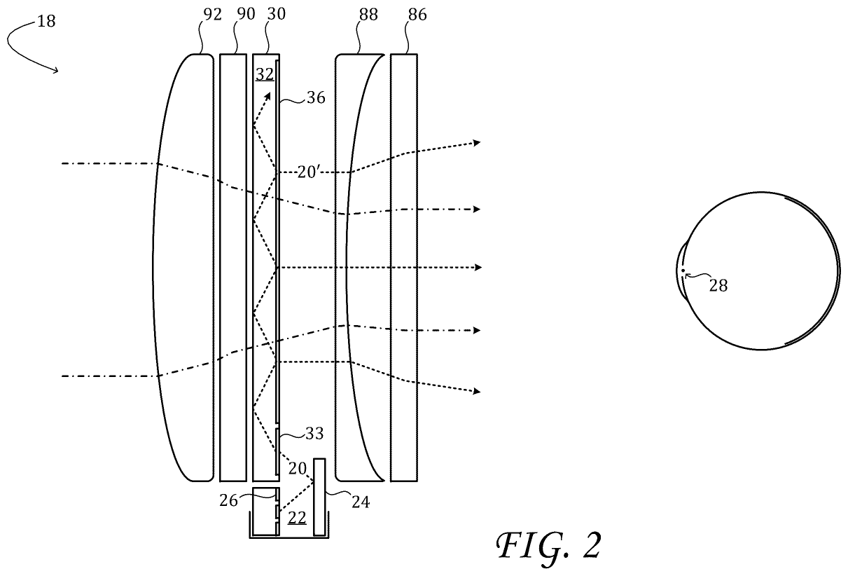

FIG. 2 shows aspects of an example monocular system 18 of near-eye display device 10. The monocular system includes a display projector 22 configured to form a display image 20. The display projector includes a high-resolution spatial light modulator (SLM) 24 illuminated by light emitters 26. The light emitters may comprise light-emitting diodes (LEDs) or laser diodes, and the SLM may comprise a liquid-crystal-on-silicon (LCOS) or digital micromirror device (DMD), for example. The SLM and the light emitters are coupled operatively to computer 12. The computer controls the matrix of independent, light-directing pixel elements of the SLM so as to cause the SLM to modulate the light received from the light emitters and thereby form display image 20. By controlling the light modulation temporally as well as spatially, the computer may cause the display projector to project a synchronized sequence of display images (i.e., video). In the example shown in FIG. 2, the display image is formed by reflection from the SLM. In other examples, a display image may be formed by transmission through a suitably configured, transmissive SLM. Display projectors based on other technologies are equally envisaged—organic LED arrays, micro-LED (μLED) arrays, scanning-laser projectors, etc.

In monocular system 18, display light from display projector 22 passes through a physical aperture of finite size. Optics downstream of the display projector focus the display light onto the anatomical right or left pupil 28 of the user. In doing so, the downstream optics direct the display light through an entry pupil, defined as the image of the physical aperture at the anatomical-pupil position. Due to the small size of the physical aperture and/or other features of monocular system 18, the entry pupil may be too small to align reliably to the user's anatomical pupil. Accordingly, monocular system 18 includes an expansion optic 30. The expansion optic is configured to receive display light through a relatively small entry pupil and to release the display light over an expanded exit pupil, which may be large enough to cover the entire area over which the user's pupil is likely to be. Such an area is called an ‘eyebox’. Herein and elsewhere, an expansion optic may also be called a ‘pupil-expansion optic’.

Continuing in FIG. 2, expansion optic 30 is configured to receive display image 20 from display projector 22 and to release an expanded form 20′ of the display image toward the pupil 28. In the illustrated example, the expansion optic includes an optical waveguide 32, an entry grating 33 and an exit grating 36. The expansion optic may also include other gratings not shown in FIG. 2, such as an intermediate grating configured to perform pupil replication. It will be understood that the term ‘grating’ is broadened herein to include any kind of diffractive optical element (DOE), irrespective of whether that element includes a pattern of elongate diffractive features. Non-limiting example gratings include a surface-relief type grating comprising a series of closely spaced channels, or a volume grating or index-modulated grating.

Entry grating 33 is a diffractive structure configured to receive display image 20 and to in-couple the light of the display image into optical waveguide 32. After coupling into the optical waveguide, the display light propagates through the optical waveguide by total internal reflection (TIR) from the front and back faces of the optical waveguide. Exit grating 36 is a diffractive structure configured to controllably release (i.e., out-couple) the propagating display light from the optical waveguide in the direction of pupil 28. To that end, the exit grating includes a series of light-extraction features arranged from weak to strong in the direction of display-light propagation through the optical waveguide. In this manner the display light is released at uniform intensity over the length of the exit grating. According to the principles set forth herein, expansion optic 30 may be configured to expand the exit pupil of display projector 22 so as to fill or slightly overfill the eyebox of the user. This condition provides desirable image quality and user comfort.

In some examples, expansion optic 30 may expand the exit pupil of display projector 22 in one direction only—e.g., the horizontal direction, in which the most significant eye movement occurs. Here the display projector itself may offer a large enough exit pupil-natively, or by way of a vertical pre-expansion stage-so that vertical expansion within the optical waveguide is not necessary. In other examples, expansion optic 30 may be configured to expand the exit pupil in the horizontal and vertical directions. In such examples, display light propagating in a first direction within the optical waveguide may encounter a turning grating (not shown in FIG. 2) having a plurality of diffraction features arranged weak to strong in a first direction. The turning grating may be configured such that the light diffracted by the diffraction features is turned so as to propagate in a second direction, having now been expanded in the first direction. Parallel rays of the expanded light then encounter exit grating 36 and are out-coupled from the waveguide as described above. Despite the utility of diffractive optical elements for coupling light into and out of an optical waveguide, in-coupling and out-coupling optical elements based on reflection, refraction, and/or scattering are also envisaged, as alternatives to DOEs.

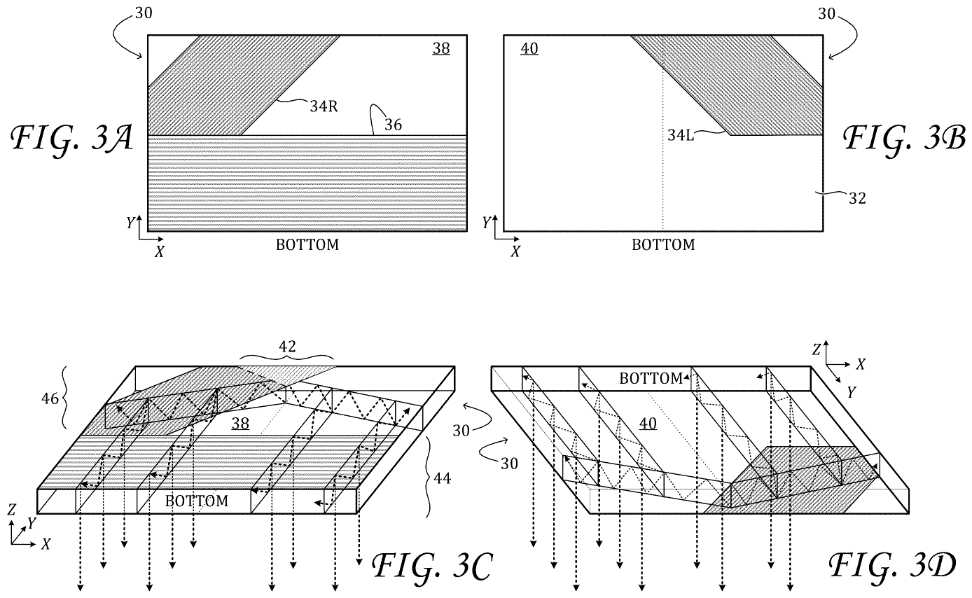

FIGS. 3A through 3D show additional aspects of expansion optic 30 in a more particular but non-limiting example. In these drawings, optical waveguide 32 comprises a transparent (e.g., glass or polymer) slab with a planar entry face 38 and an opposing, planar exit face 40. For ease of description, the entry face and the exit face are also referred to as ‘surfaces’ of the waveguide—front surface 38 and rear surface 40, respectively. The opposite correspondence is also envisaged, however. FIG. 3A is a plan view of entry face 38; FIG. 3B is a view of exit face 40 as seen through the entry face. FIGS. 3C and 3D are perspective views of the expansion optic 30 rotated in opposite directions about a horizontal axis aligned to the forward edge.

Expansion optic 30 includes an entry zone 42 where the display image is received through entry face 38 and an exit zone 44 where the expanded form of the display image is released through exit face 40. The expansion optic also includes an initial-expansion zone 46 that receives the display light from entry zone 42 and expands the display light en route to the exit zone. Expansion optic 30 may include a plurality of differently configured diffraction gratings arranged in the different zones.

In the illustrated example, rightward expansion grating 34R is arranged on entry face 38, and leftward expansion grating 34L is arranged on exit face 40. The rightward and leftward expansion gratings are entry gratings that extend through initial-expansion zone 46 and overlap in entry zone 42. Exit grating 36 is arranged on entry face 38, in exit zone 44. In other examples, any, some, or all of the diffraction gratings enumerated above may be arranged on the opposite face of the optical waveguide relative to the illustrated configuration.

Operationally, low-angle display light is received in entry zone 42, through entry face 38. Rightward expansion grating 34R and leftward expansion grating 34L cooperate to couple the low-angle display light into optical waveguide 32. Specifically, leftward expansion grating 34L diffracts some of the incoming, low-angle display light obliquely rightward and downward at a supercritical angle, such that it now propagates through the optical waveguide in a rightward and downward direction. At each bounce from entry face 38, the propagating light encounters rightward expansion grating 34R, which directs successive, increasing portions of the light directly downward. This function expands the display light in the rightward direction and conveys the rightward-expanded display light into exit zone 44. In a complementary manner, rightward expansion grating 34R diffracts some of the incoming, low-angle display light obliquely leftward and downward at a supercritical angle, such that it propagates through the optical waveguide in a leftward and downward direction. At each bounce from exit face 40, the propagating light encounters the leftward expansion grating, which directs successive, increasing portions of the light directly downward. This function expands the display light in the leftward direction and conveys the leftward-expanded display light into exit zone 44. In the exit zone, the propagating display light at each bounce from entry face 38 encounters exit grating 36, which directs successive, increasing portions of the rightward- and leftward-expanded display light out of optical waveguide 32. In this manner, the display light is expanded in the downward direction—i.e., perpendicular to the rightward and leftward expansion effected by the right- and leftward expansion gratings.

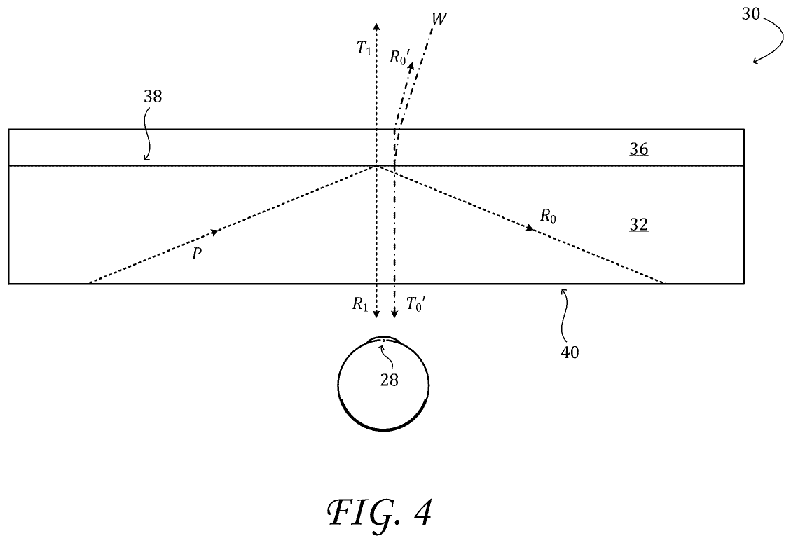

FIG. 4 shows aspects of expansion optic 30 in a simplified form sufficient to illustrate the issues addressed in this disclosure. In this drawing, P represents a ray of display light propagating through optical waveguide 32. Most of the display light is reflected back into the waveguide by internal reflection at front surface 38; R₀ represents the intensity of the ray that continues to propagate through the waveguide. R₁ represents the intensity of the ray which, by interaction with exit grating 36, reflects back toward the pupil 28 of the wearer, and T₁ represents the intensity of the ray reflected in the opposite direction, out into the world. The branching ratio R₁/T₁ defines the relative amount of desired versus undesired out-coupled intensity. T₁ is undesired because it represents a reduction in the available R₁. In some examples and scenarios, T₁ is undesired also because it imparts a glow to the waveguide/out-coupler assembly. This effect is called ‘eye glow’. Eye glow may reveal the location of the wearer in a dark environment and/or reveal that otherwise inconspicuous eyewear comprises a near-eye display device. In order to address these issues, a relatively large R₁/T₁ branching ratio is generally desired.

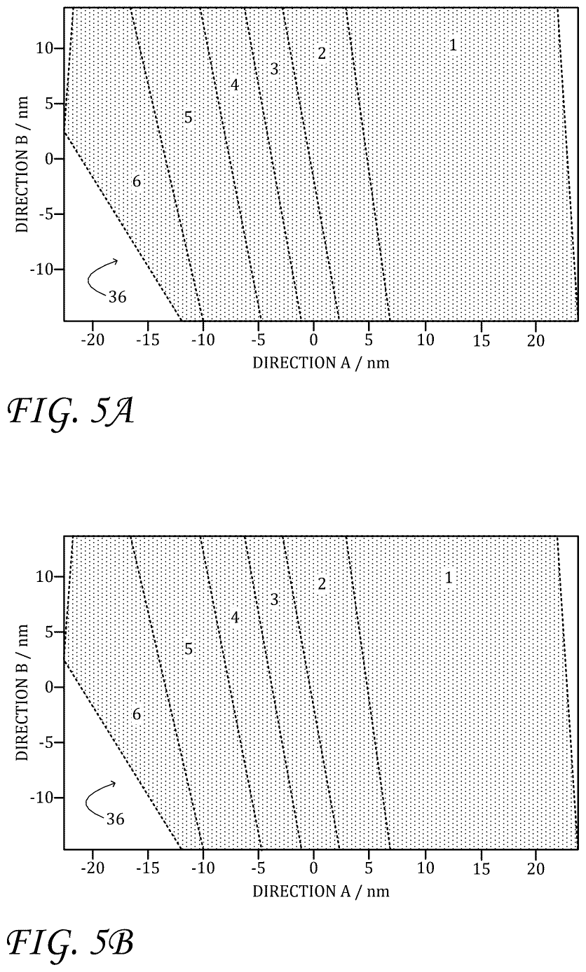

FIGS. 5A and 5B show additional aspects of example exit grating 36. As noted hereinabove, the out-coupling efficiency of the exit grating is configured to increase along the direction of propagation of the display light through the underlying optical waveguide. In both comparative and disclosed examples, accordingly, grating properties such as feature size, feature depth, fill factor, and pitch may vary along and across the exit grating. In some examples, such properties may vary as smooth, continuous functions of the coordinates (e.g., X and Y) on the rear surface 40 of the exit grating. For ease of description, however, it is convenient to divide the rear surface into a finite number of regions, across which the feature size, feature depth, fill factor and/or pitch may vary as step functions. Accordingly, FIG. 5A shows the depth profile and FIG. 5B the companion fill profile for an example exit grating 36, each divided into six numbered regions via tightly dashed lines. For the comparative examples herein, each of the six numbered regions supports a ‘linear slanted grating’. A linear slanted grating is a one-dimensional array of replicated, elongate, nanometer-scale features (such as grooves or ridges) arranged parallel to the rear surface of the exit grating; the features themselves may be aligned obliquely relative to the rear surface.

TABLE 1
Selected parameters for linear slanted gratings
usable for the exit grating of FIGS. 5A and 5B.

| | grating | | bar | | bias | | | | | |
|---|---|---|---|---|---|---|---|---|---|---|
| | depth/ | fill | width/ | slant/ | thickness/ | | | | | R₁ |
| region | nm | factor | nm | degrees | nm | R₀ | R₁ | T₁ | R₁/T₁ | (RMS) |
| 1 | 25 | 0.75 | 255 | 44.370 | 640.0 | 0.981 | 0.010 | 0.005 | 1.957 | 0.011 |
| 2 | 50 | 0.7 | 238 | 44.370 | 627.2 | 0.924 | 0.040 | 0.020 | 1.997 | 0.043 |
| 3 | 75 | 0.675 | 230 | 44.370 | 614.4 | 0.861 | 0.069 | 0.031 | 2.263 | 0.075 |
| 4 | 100 | 0.65 | 221 | 44.370 | 601.7 | 0.808 | 0.101 | 0.032 | 3.150 | 0.110 |
| 5 | 150 | 0.6 | 205 | 44.370 | 576.1 | 0.738 | 0.180 | 0.019 | 9.610 | 0.202 |
| 6 | 200 | 0.55 | 187 | 44.370 | 550.6 | 0.688 | 0.240 | 0.014 | 16.860 | 0.282 |

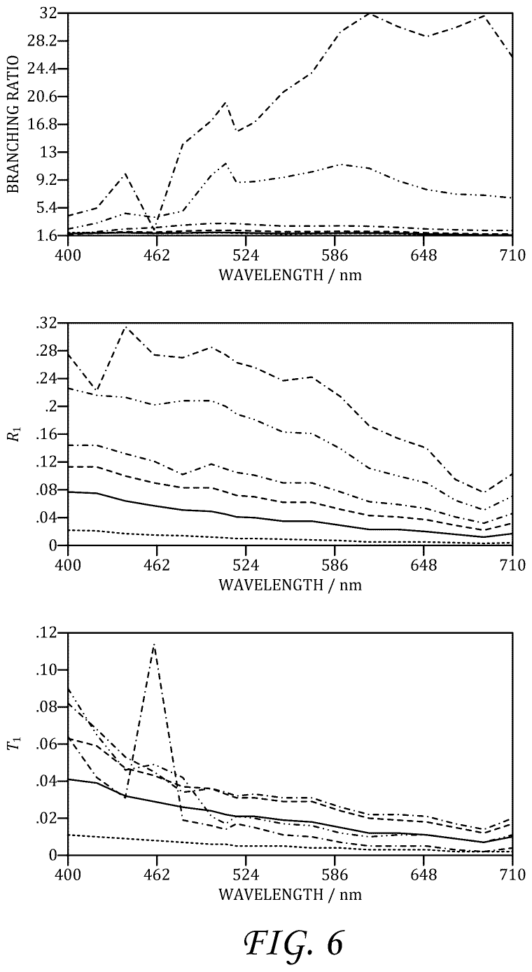

Table 1 summarizes selected parameters for the six numbered regions of exit grating 36, in a comparative example in which all six regions comprise linear slanted gratings. It is evident from this data that R₁/T₁ is lowest (least satisfactory) for region 1, in which the grating depth is relatively shallow. The optical parameters reported in Table 1 are averaged over a wavelength range appropriate for near-eye display applications. As shown in FIG. 6, however, R₁, T₁, and the branching ratio R₁/Ti are all wavelength-dependent. In FIG. 6, the tightly dotted line represents linear slanted grating C1 (at level 1), the solid line represents linear slanted grating C2 (at level 2), the dashed line represents linear slanted grating C3 (at level 3), the dot-dashed line represents linear slanted grating C4 (at level 4), the double-dot dashed line represents linear slanted grating C5 (at level 5), and the double-dash dotted line represents linear slanted grating C6 (at level 6).

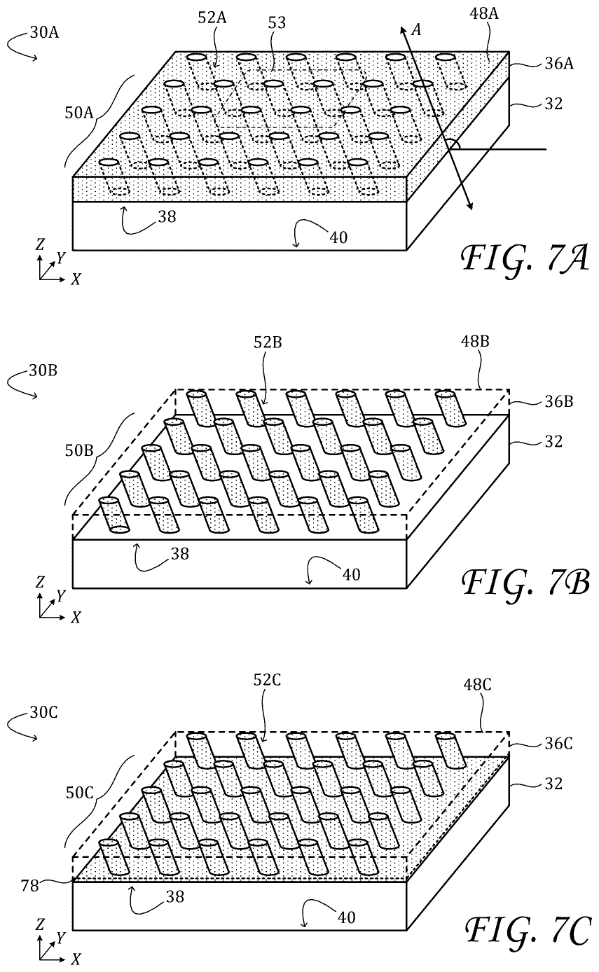

This disclosure aims to increase R₁/T₁ relative to the values observed in comparative examples, thereby increasing display brightness and reducing eye glow. To that end, FIG. 7A shows aspects of an example expansion optic 30A. The expansion optic comprises an optical waveguide 32. The optical waveguide has a front surface 38 and a rear surface 40 opposite the front surface. As in the examples hereinabove, the optical waveguide supports TIR of display light from the front and rear surfaces.

Exit grating 36A is configured to release display light from the optical waveguide. In the illustrated example the exit grating includes a patterned metagrating layer 48A. In some examples the metagrating layer may comprise a cured optical resin and optionally may comprise a nanoparticle filler, for adjustment of the refractive index of the cured resin. In some examples the metagrating layer may comprise a non-molecular material, such as an oxide or a nitride. Whether comprising a cured resin or a non-molecular material, the metagrating layer may have a refractive index suitable for extracting light from optical waveguide 32. In examples in which the optical waveguide comprises glass of refractive index 1.5 to 1.7 or higher, the dielectric of the exit grating may have a refractive index in the range of 1.9 to 2.0. A metagrating layer comprising silicon nitride may have a refractive index as higher as 2.4.

Continuing in FIG. 7A, patterned metagrating layer 48A includes a two-dimensional matrix 50A of replicated, nanometer-scale features 52A. Herein and elsewhere, such a matrix may be called a ‘metagrating’. The nanometer-scale features are distributed parallel to front surface 38 and parallel to rear surface 40 of optical waveguide 32. This disclosure contemplates nanometer-scale features 52 of various kinds. In the example illustrated in FIG. 7A each nanometer-scale feature 52A is a recess feature—e.g., a well—formed in metagrating layer 48A. Each nanometer-scale feature 52A has a longest dimension and an axis A aligned to the longest dimension. In the illustrated example the axes of each of the nanometer-scale features are oblique to the front surface and to the rear surface of the optical waveguide. Moreover, each of the axes is mutually parallel within a locality 53 of matrix 50A.

In practice, it was found that unit cells comprising a single, oblique through hole provide satisfactory performance for levels 3 through 6, as defined above. For levels 1 and 2, however, better performance was achieved with two, oblique through holes per unit cell. In each case a relatively high aspect ratio (e.g., 200 nm depth at 80 nm diameter) and a significant axis tilt (e.g., 35 to 45° relative to the front and rear surfaces of the optical waveguide) give superior performance. Despite the efficacy of these results, the foregoing patterns should not be construed to limit the scope of this disclosure, as different patterns are also envisage—e.g., patterns having different densities and/or sizes of wells and/or pillars. Furthermore, usable metagrating patterns are not limited to wells and pillars of the illustrated shapes. Substantially more freeform shapes may also be used, with densities and dimensions tuned to the desired diffraction properties.

FIG. 7B shows aspects of another example expansion optic 30B. Expansion optic 30B is identical in every respect to expansion optic 30A, apart from the features noted herein. The replicated, nanometer-scale features 52B of expansion optic 30B are protrusive features—e.g., pillars comprising the metagrating-layer material, as opposed to wells formed in the metagrating-layer material. Thus, patterned metagrating layer 48B of expansion optic 30B may be a discontinuous layer. As in the previous example the metagrating material may comprise either cured resin or a non-molecular material of suitable refractive index. Each nanometer-scale feature has a longest dimension and an axis aligned to the longest dimension. In some examples the axes may be oblique to the front and/or rear surfaces of the optical waveguide, and each of the axes may be mutually parallel within a locality of matrix 50B. Some exit gratings fully consonant with this disclosure may include recess and protrusive features in the same matrix, in the same numbered region of a matrix, or in the same locality within a region.

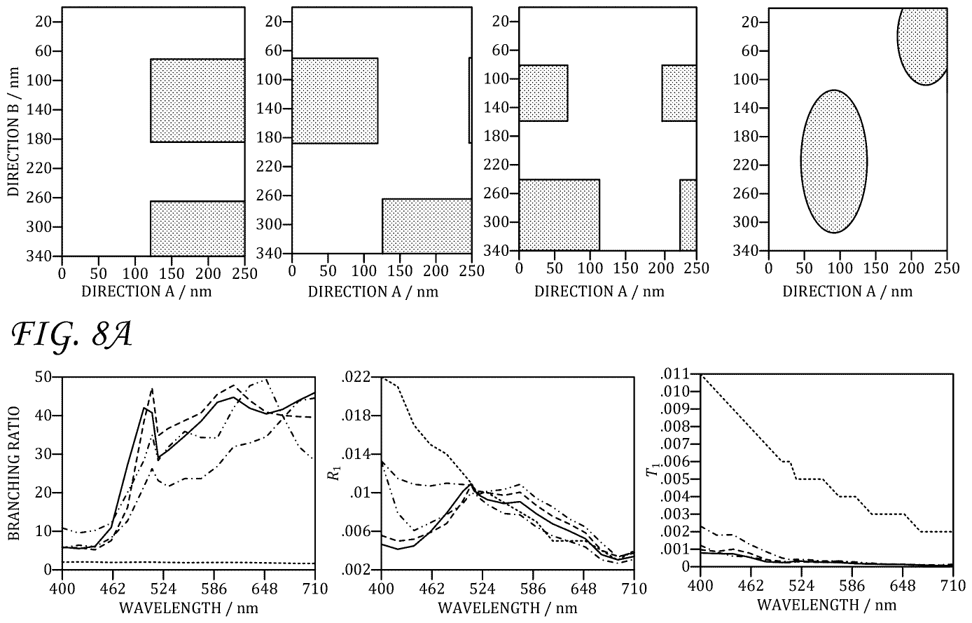

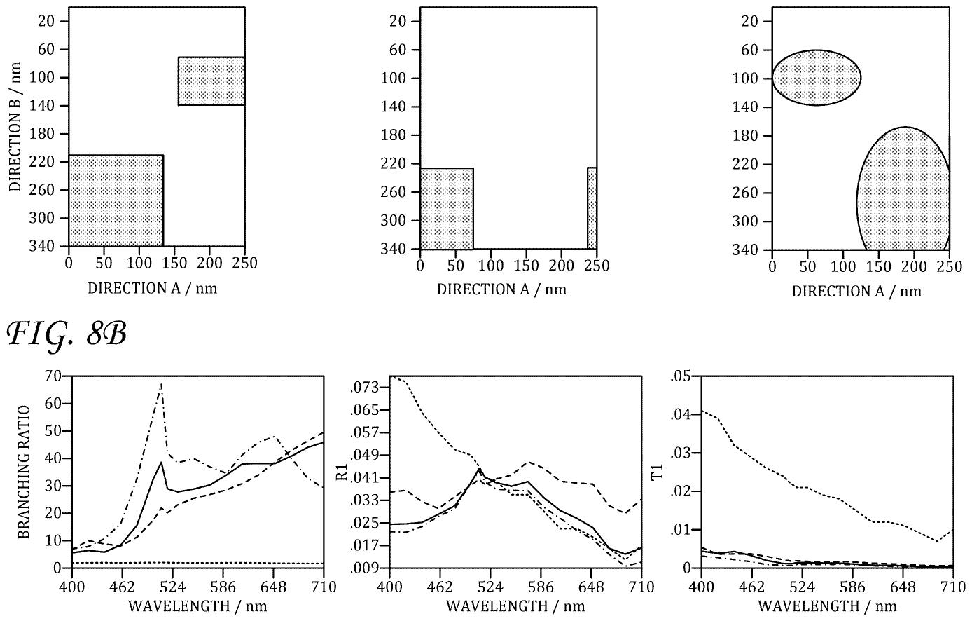

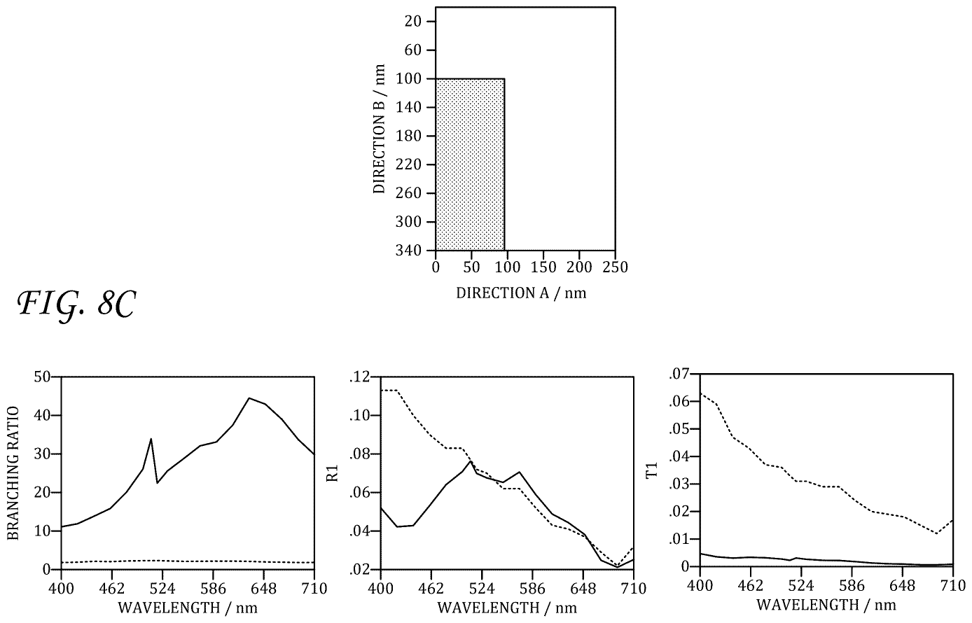

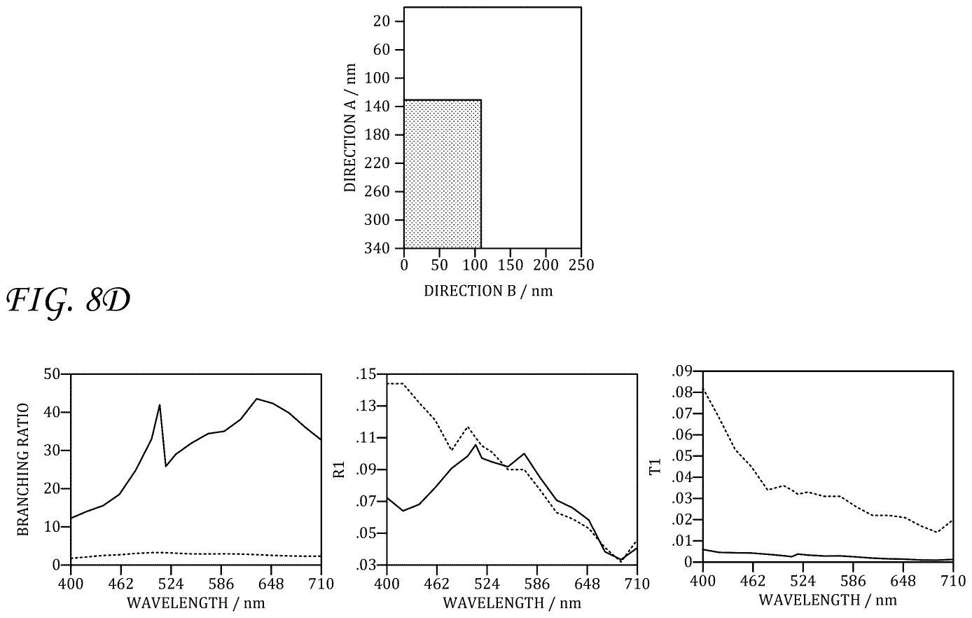

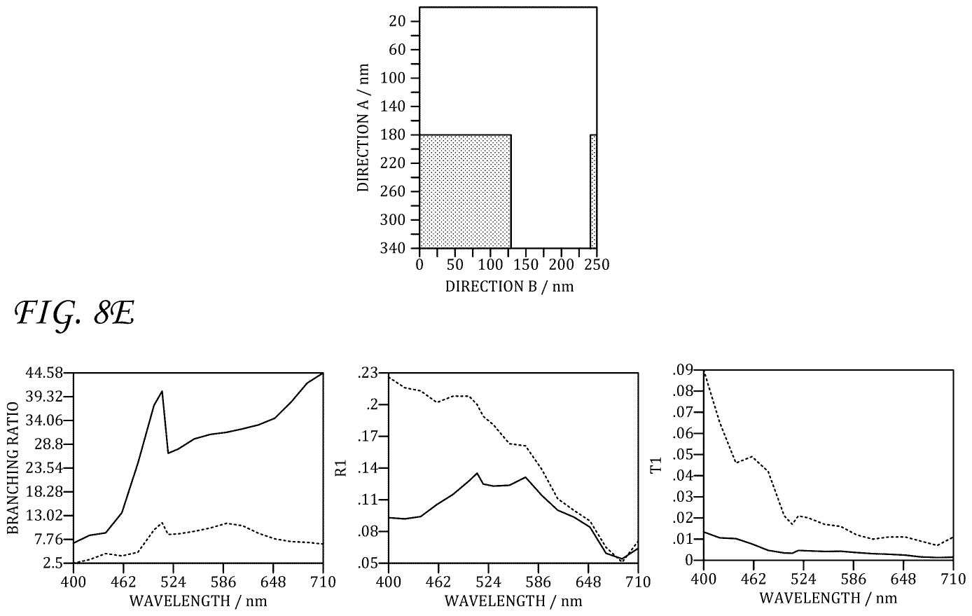

Generally speaking, the size, shape, axis orientation, and/or spatial period of the nanometer-scale features may vary along an exit grating—e.g., along the direction of propagation of light through the underlying optical waveguide. As the direction of propagation may not necessarily coincide with the longitudinal axis of the exit grating, the term ‘along’ should not be interpreted in a limiting sense. In other words, the size, shape, axis orientation, and/or spatial period of the nanometer-scale features 52 may vary across an exit grating, alternatively or in addition to along the same exit grating. This feature is developed in greater detail in FIGS. 8A through 8E.

FIGS. 8A through 8E show data for example metagrating matrices that can be used in the various regions of an exit grating of an optic. Each drawing shows, in the upper half, one or more example metagrating topologies available for the indicated region. Each drawing also shows, in the lower half, plots of R₁, T₁, and the branching ratio R₁/T₁ for the example metagrating topologies and for a comparable linear slanted grating. In each case, the example metagrating matrix has recess features. No data is provided for region 6, where a linear slanted grating gives satisfactory performance.

FIG. 8A shows the data for grating level 1, where the minimum feature size was 70 to 80 nm, the grating depth was about 200 nm, and the slant angle was 45°. The solid line represents metagrating 1 of feature depth 200 nm. The dashed line represents metagrating 2 of feature depth 200 nm. The dot-dashed line represents metagrating 3 of feature depth 200 nm. The double-dot dashed line represents metagrating 4 of feature depth 200 nm. For comparison, the tightly dotted line represents linear slanted grating C1 of feature depth 25 nm.

FIG. 8B shows the data for grating level 2, where the minimum feature size was 70 to 80 nm, the grating depth was about 200 nm, and the slant angle was 45°. The solid line represents metagrating 5 of feature depth 200 nm. The dashed line represents metagrating 6 of feature depth 200 nm. The dot-dashed line represents metagrating 7 of feature depth 200 nm. For comparison, the tightly dotted line represents linear slanted grating C2 of feature depth 50 nm.

FIG. 8C shows the data for grating level 3, where the grating depth was about 200 nm, and the slant angle was 45°. The solid line represents metagrating 8 of feature depth=200 nm. For comparison, the tightly dotted line represents linear slanted grating C3 of feature depth 75 nm.

FIG. 8D shows the data for grating level 3, where the grating depth was about 200 nm, and the slant angle was 45°. The solid line represents metagrating 9 of feature depth 200 nm. For comparison, the tightly dotted line represents linear slanted grating C4 of feature depth 100 nm.

FIG. 8E shows the data for grating level 3, where the grating depth was about 200 nm, and the slant angle was 45°. The solid line represents metagrating 10 of feature depth 200 nm. For comparison, the tightly dotted line represents linear slanted grating C5 of feature depth 150 nm.

The data in FIGS. 8A through 8E show that metagratings can match the out-coupling efficiency of conventional linear slanted gratings when used as waveguide out-coupler for near-eye display applications. The out-coupling efficiency is the same or better for the shallowest gratings, for the deepest gratings, and for all levels in between. Significantly, the shallowest linear slanted gratings exhibit disadvantageous world-side leakage. The metagratings here disclosed suppress the world-side leakage over a broad wavelength band. The table below summarizes the observed improvement relative to the conventional linear slanted grating for 517.5 nm display light, at a metagrating depth of 200 nm.

TABLE 2
Improvement in R₁/T₁ for metagratings
relative to linear slanted gratings.

| depth/nm | relative improvement in R₁/T₁ % |
|---|---|
| <25 | 93.2 |
| 25 to 50 | 95.4 |
| 50 to 75 | 89.9 |
| 75 to150 | 88.2 |
| >150 | 77.9 |

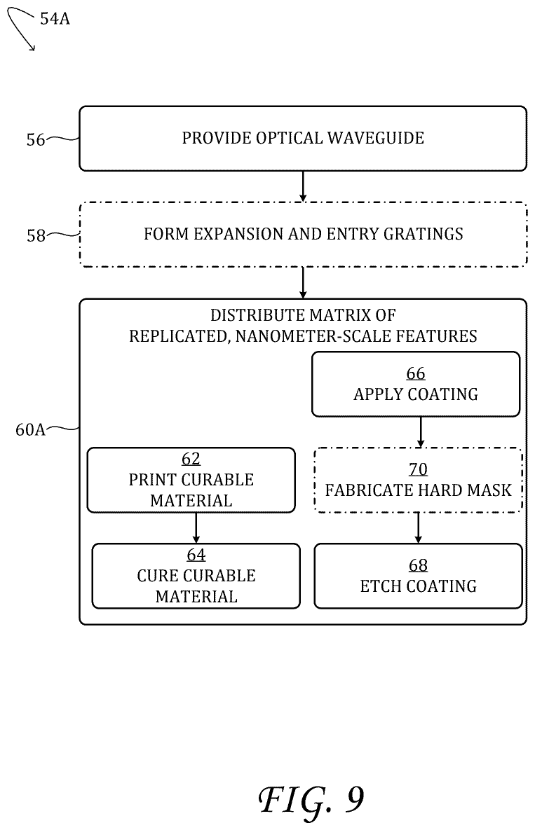

FIG. 9 shows aspects of an example method 54A for making an optic, such as any of the expansion optics introduced hereinabove. It will be understood, however, that method 54A may also be applicable to making optics that differ in some respects from the optic configurations here disclosed.

At 56 of method 54A, an optical waveguide is provided. The optical waveguide has front and rear surfaces and supports TIR of display light from the front and rear surfaces. In some examples the optical waveguide may comprise glass. At optional step 58, suitable expansion and entry gratings are formed on the optical waveguide.

At 60A a two-dimensional matrix of replicated, nanometer-scale features is distributed on the optical waveguide, parallel to the front and/or rear surface of the optical waveguide. The matrix of replicated, nanometer-scale features comprises an exit grating. In some examples each of the nanometer-scale features comprises a recess feature, such as a well formed in the metagrating layer. In some examples each of the nanometer-scale features comprises a protrusive feature, such as a pillar formed from the metagrating-layer material.

In some variants of method 54A, the act of distributing the two-dimensional matrix comprises, at 62, printing curable material in a pattern corresponding to the replicated, nanometer-scale features. The curable material may comprise a curable resin, a ceramic precursor, etc. In these variants the curable material is cured at 64. Curing may comprise thermal and/or photochemical curing, depending on the nature of the curable material. In some examples the curable material may comprise a resin and a nanoparticle filler having a refractive index higher or lower than that of the resin, as noted hereinabove. Thin-film deposition techniques, such as inkjet printing, are capable of maintaining nanometer-scale resolution over a macroscopic surface, such as the surface of the expansion optic of a near-eye display device. In some examples the resolution may be limited only by the size of the nanoparticles used to adjust the refractive index—e.g., about 10 nm with current technology.

In some variants of method 54A, the act of distributing the two-dimensional matrix includes, at 66, application of a coating to the optical waveguide. Suitable coatings may be applied via atomic-layer deposition (ALD), chemical vapor deposition (CVD), physical vapor deposition (PLD), and/or spin coating, for example. In these variants the coating, at 68, is selectively etched in a pattern corresponding to the replicated, nanometer-scale features. In more particular examples, the act of selectively etching the coating comprises additional steps of fabricating a hard mask, at 70, through which the coating is etched. The hard mask is a thin film of a material with better etch selectivity with respect to the material being etched than photoresist. The hard mask material can vary depending upon the etching process used. The hard mask may be fabricated by deposition of a hard mask layer followed by photolithography, for instance. In examples in which directional etching is used, the etching may be enacted in a direction oblique to the front and/or rear surface of the optical waveguide.

In some examples the hard mask comprises chromium which is patterned by via traditional photolithography. Dielectric etching is then used to replicate the features defined geometrically by the chromium hard mask. The dielectric etching may comprise electron-beam lithography (EBL), plasma etching, and/or ion-beam lithography (IBT) as examples.

Returning now to FIG. 4, W represents a ray of light from the environment external to expansion optic 30—i.e., from the outside world. In this drawing R₀′ represents the intensity of ray W reflected back into the environment, and T₀′ represents the intensity transmitted to pupil 28 of the wearer. Naturally, in near-eye display systems configured for AR operation, where transparency is desirable, the branching ratio T₀′/R₀′ is a feature to be optimized. Table 3 reprises the parameters of the linear slanted gratings introduced in Table 1, together with measured values of R₀′, T₀′, and the branching ratio T₀′/R₀′.

TABLE 3
Parameters of linear slanted gratings in the six regions of
FIGS. 5A and 5B and values of R₀′ and T₀′ computed
for a 10 × 10 field of view, and of the branching ratio T₀′/R₀′.

| | grating | | bar | | bias | R₀′ mean | T₀′ mean |
|---|---|---|---|---|---|---|---|
| | depth/ | fill | width/ | slant/ | thickness/ | (see- | (see- |
| region | nm | factor | nm | degree | nm | through) | through) |
| 1 | 25 | 0.75 | 255 | 44.370 | 640.0 | 0.103 | 0.884 |
| 2 | 50 | 0.7 | 238 | 44.370 | 627.2 | 0.078 | 0.866 |
| 3 | 75 | 0.675 | 230 | 44.370 | 614.4 | 0.050 | 0.836 |
| 4 | 100 | 0.65 | 221 | 44.370 | 601.7 | 0.038 | 0.777 |
| 5 | 150 | 0.6 | 205 | 44.370 | 576.1 | 0.086 | 0.579 |
| 6 | 200 | 0.55 | 187 | 44.370 | 550.6 | 0.101 | 0.441 |

TABLE 4
Comparison of optical parameters for expansion optics with metagrating exit gratings. R₁′ and T₁′ are computed
for a 10 × 10 field of view. HRI refers to a layer of the higher refractive-index material, and LRI refers to a layer
of the lower refractive-index material. (In the actual computation, R and T were exchanged because the simulated out-coupler
(and anti-reflective laminae, if any) were arranged on the opposite side of the waveguide, relative to the foregoing examples.)

| | | hole | hole | HRI 1 | LRI 1 | HRI 2 | LRI 2 | HRI 3 | | | | | | | | |
|---|---|---|---|---|---|---|---|---|---|---|---|---|---|---|---|---|
| | height/ | size X/ | size Y/ | height/ | height/ | height/ | height/ | height/ | slant/ | bias/ | | | | | | |
| config | nm | nm | nm | nm | nm | nm | nm | nm | deg | nm | T₁ | T₂ | R₁ | R₁/T₁ | R₀′ | T₀′ |
| 10940 | 142.7 | 122.6 | 235.6 | 0 | 0 | 0 | 0 | 0 | −45 | 395.9 | 0.0026 | 0.006 | 0.105 | 40 | 0.088 | 0.859 |
| ORIG | | | | | | | | | | | | | | | | |
| 10940 | 142.7 | 122.6 | 235.6 | 0 | 0 | 0 | 0 | 0 | −45 | 0 | 0.0026 | 0.006 | 0.101 | 39 | 0.090 | 0.858 |
| ZERO | | | | | | | | | | | | | | | | |
| BIAS | | | | | | | | | | | | | | | | |
| 10940 | 142.7 | 122.6 | 235.6 | 1.28 | 72.62 | 6.68 | 82.95 | 68.72 | −45 | 0 | 0.0016 | 0.000 | 0.095 | 61 | 0.171 | 0.820 |
| 1282 | | | | | | | | | | | | | | | | |

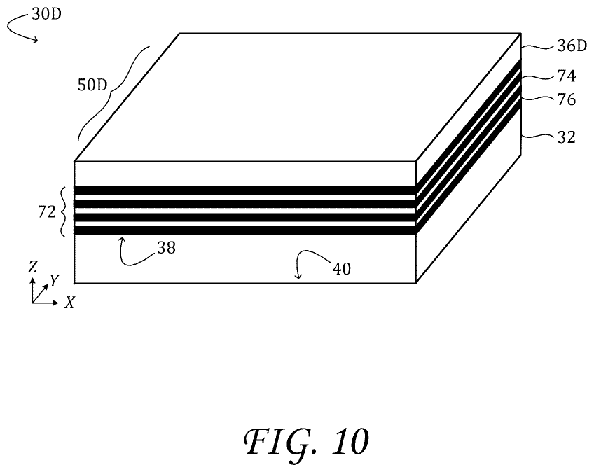

FIG. 10 shows aspects of another example expansion optic 30D, configured for improved see-thru transparency relative to the foregoing examples. Expansion optic 30D is identical in every respect to the expansion optics hereinabove, apart from the features noted herein.

Expansion optic 30D includes a series of anti-reflective laminae 72 formed on optical waveguide 32. The series of anti-reflective laminae are arranged parallel to the front surface 38 and parallel to rear surface 40 of the optical waveguide. Exit grating 36D of expansion optic 30D is formed on the series of anti-reflective laminae 72 and configured to release the display light from the optical waveguide. As in the previous examples, exit grating 36D includes a two-dimensional matrix 50D of replicated, nanometer-scale features distributed parallel to front surface 38 and parallel to rear surface 40.

Generally speaking, the series of anti-reflective laminae 72 comprise layers of alternating refractive index. Such layers comprise a first material 74 of a first refractive index and a second material 76 of a second refractive index. The first refractive index may be greater than the second refractive index at one or more wavelengths. For example, the first material may comprise titania (TiO₂), with a refractive index of about 2.28; the second material may comprise silica (SiO₂), with a refractive index of 1.46. Laminae of these materials provide appropriate anti-reflective interference in configurations in which optical waveguide comprises glass, refractive index 1.5 to 1.7 or higher, and in which the metagrating-layer material of the exit grating has a refractive index 1.9 to 2.0. Suitable laminae may be applied using ALD, CVD, spin-coat, and/or inkjet printing. Although seven anti-reflective layers are shown in the drawing, series comprising a greater or lesser number of layers are also envisaged.

This disclosure contemplates two general variants for exit grating 36D. These variants are distinguished most easily with reference to FIGS. 7A through 7C, which show matrices 50 in schematic detail. Turning first to FIG. 7C, nanometer-scale features 52C of matrix 50C emerge from a bias layer 78 of metagrating-layer material, which has non-zero bias thickness. The term ‘bias layer’ refers to the thin layer of metagrating-layer material between the nanometer-scale features and the waveguide. In this example the nanometer-scale features are distributed on the bias layer, and the bias layer and the nanometer-scale features have equivalent refractive index. By contrast, there is no bias layer between the nanometer-scale features 52B and waveguide 32 in exit grating 36B of FIG. 7B. The same dichotomy is envisaged for recessive nanometer-scale features 52A of FIG. 7A: the slanted wells may extend all the way through metagrating layer 48A in some examples but may leave below a thin, bias layer of the metagrating-layer material in other examples.

The data in Table 4 provide a comparison of observed optical parameters for expansion optics with metagrating exit gratings. These data illustrate the effects of the anti-reflective laminae and of the bias thickness.

Returning now to FIG. 10, where a series of anti-reflective laminae 72 are arranged between waveguide 32 and exit grating 36D, both of the above variants are envisaged. In some examples the nanometer-scale features of the exit grating are arranged on a bias layer of non-zero thickness and supported on the series of anti-reflective laminae (opposite the waveguide). In other examples the nanometer-scale features of the exit grating are distributed directly onto the series of anti-reflective laminae 72, with no intervening bias layer.

TABLE 5
World-side leakage and transmittance at 517.5 nm.

| | depth/ | world-side | |
|---|---|---|---|
| configuration | nm | leakage | transmittance |
| linear slanted grating | 54 | 0.047 | 0.88 |
| metagrating 1 optimized for | 54 | 0.030 | 0.94 |
| see-through transmittance | | | |
| metagrating 2 optimized for | 54 | 0.011 | 0.59 |
| leakage | | | |
| linear slanted grating | 154 | 0.007 | 0.82 |
| metagrating 1 | 154 | 0.003 | 0.94 |

The data in Table 5 above show that incorporation of anti-reflective laminae 72 in an expansion optic is effective for suppressing world-side leakage and achieving improved see-thru transparency. These effects are especially relevant to near-eye display devices configured for AR applications.

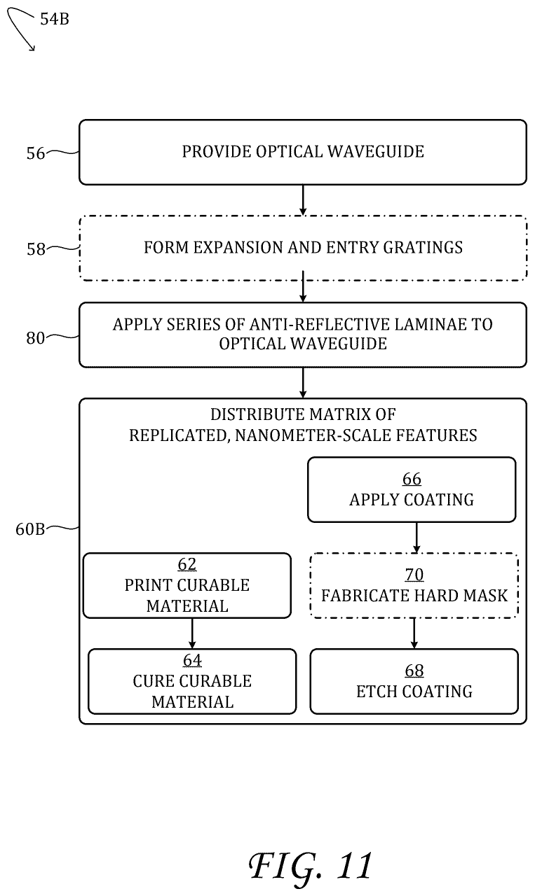

FIG. 11 shows aspects of an example method 54B for making an optic, such as any of the expansion optics introduced hereinabove. It will be understood, however, that method 54B may also be applicable to making optics that differ in some respects from the optic configurations here disclosed.

At 56 of method 54B, an optical waveguide is provided. The optical waveguide has front and rear surfaces and supports total internal reflection of display light from the front and rear surfaces. At optional step 58, suitable expansion and entry gratings are formed on the optical waveguide.

At 80 a series of anti-reflective laminae is applied to the optical waveguide, parallel to the front and/or rear surface of the optical waveguide. In some examples the act of applying the series of anti-reflective laminae comprises ALD, CVD, and/or PVD. In some examples the act of applying the series of anti-reflective laminae comprises printing and/or spin coating.

At 60B a two-dimensional matrix of replicated, nanometer-scale features is distributed on the series of anti-reflective laminae, parallel to the front and/or rear surface of the optical waveguide. The matrix of replicated, nanometer-scale features comprises an exit grating. In some examples each of the nanometer-scale features comprises a recess feature, such as a well. In some examples each of the nanometer-scale features comprises a protrusive feature, such as a pillar.

In some variants of method 54B, the act of distributing the two-dimensional matrix comprises, at 62, printing curable material in a pattern corresponding to the replicated, nanometer-scale features. In those variants the curable material is cured at 64. Inkjet printing, for instance, can be used to provide a patterned metagrating layer of zero bias thickness.

In some variants of method 54B, the act of distributing the two-dimensional matrix comprises, at 66, applying a coating to the optical waveguide. In these variants the coating is selectively etched at 68 in a pattern corresponding to the replicated, nanometer-scale features. In more particular examples, the act of selectively etching the coating comprises additional steps of fabricating a hard mask, at 70, through which the coating is etched. The hard mask may be fabricated via lithography, for instance. In examples in which directional etching is used, the etching may be enacted in a direction oblique to the front and/or rear surface of the optical waveguide.

No aspect of the foregoing drawings or description should be interpreted in a limiting sense, because numerous variations, extensions, and omissions are also envisaged. For example, although metagratings may be used to provide the out-coupling function for every region of an optical waveguide (e.g., the six regions of FIGS. 5A and 5B), that aspect is not necessary. Rather, a given exit grating may comprise, in addition to one or more metagratings, at least one one-dimensional array of replicated, elongate, nanometer-scale features arranged parallel to the surface (e.g., a linear slanted grating). The methods of manufacture disclosed herein are fully consonant with concurrent or sequential formation of both kinds of out-coupling gratings, via mutually compatible modes of fabrication.

Continuing now with other aspects of a near-eye display device, each display image formed by monocular system 18 is a virtual image presented at a predetermined distance Z₀ in front of user O. The distance Z₀ is referred to as the ‘depth of the focal plane’ of the display image. In some monocular systems, the value of Z₀ is a fixed function of the design parameters of display projector 22, entry grating 33, exit grating 36, and/or other fixed-function optics. Based on the permanent configuration of these structures, the focal plane may be positioned at a desired depth. In one example, Z₀ may be set to ‘infinity’, so that each optical system presents a display image in the form of collimated light rays. In another example, Z₀ may be set to 200 centimeters, requiring the optical system to present each display image in the form of diverging light. In some examples, Z₀ may be chosen at design time and remain unchanged for all virtual imagery presented by the display system. Alternatively, the optical systems may be configured with electronically adjustable optical power, to allow Z₀ to vary dynamically according to the range of distances over which the virtual imagery is to be presented.

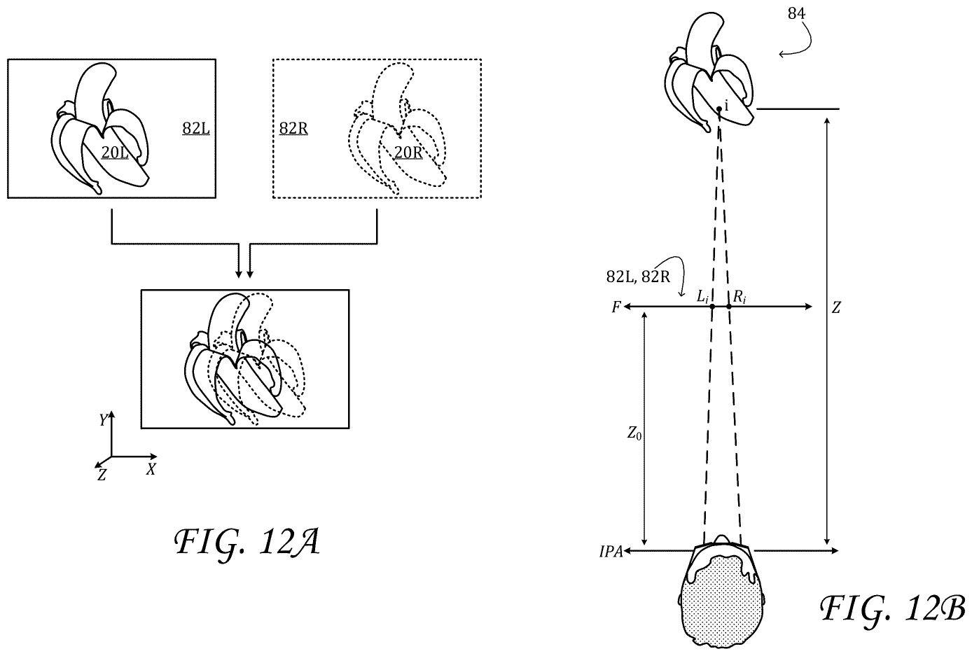

A binocular near-eye display device employing a fixed or variable focal plane may be capable of presenting virtual-display imagery perceived to lie at a controlled, variable distance in front of, or behind, the focal plane. This effect can be achieved by controlling the horizontal disparity of each pair of corresponding pixels of the right and left stereo images, as described below with reference to FIGS. 12A and 12B.

FIG. 12A shows right and left image frames 82R and 82L overlaid upon each other for ease of illustration. The right image frame encloses right display image 20R, and the left image frame encloses left display image 20L. Viewed concurrently through a near-eye display device 10, the right and left display images may appear to the user as 3D hologram 84, comprised of individually rendered loci. Each locus i of the visible surface of the hologram has a depth coordinate Zᵢ associated with a corresponding pixel (Xᵢ, Yᵢ) of each of the right and left display images. The desired depth coordinate may be simulated as follows.

At the outset, a distance Z₀ to a focal plane F of the near-eye display system is chosen. Then the depth coordinate Z for every locus i of the visible surface of the hologram is set. This is done by adjusting the positional disparity of the two pixels corresponding to locus i in the right and left display images relative to their respective image frames. In FIG. 12B, the pixel corresponding to locus i in the right image frame is denoted Rᵢ, and the corresponding pixel of the left image frame is denoted Lᵢ. In FIG. 12B, the positional disparity is positive—i.e., Rᵢ is to the right of Lᵢ in the overlaid image frames. Positive positional disparity causes locus i to appear behind focal plane F. If the positional disparity were negative, the locus would appear in front of the focal plane. Finally, if the right and left display images were superposed (no disparity, Rᵢ and Lᵢ coincident) then the locus would appear to lie directly on the focal plane. Without tying this disclosure to any particular theory, the positional disparity D may be related to Z, Z₀, and to the interpupilary distance (IPD) of the user by

$$D = IPD \times ( 1 - \frac{{Z}_{0}}{Z} ) .$$

In some examples, computer 12 maintains a model of the Cartesian space in front of the user, in a frame of reference fixed to near-eye display device 10. The user's pupil positions are mapped onto this space, as are the image frames 82R and 82L, each positioned at the predetermined depth Z₀. Then, the visible surface of hologram 84 is assembled, with each locus i of the viewable surface of the imagery having coordinates Xᵢ, Yᵢ, and Zᵢ, in the common frame of reference. For each locus of the visible surface, two-line segments are constructed—a first line segment to the pupil of the user's right eye and a second line segment to the pupil of the user's left eye. The pixel Rᵢ of the right display image, which corresponds to locus i, is taken to be the intersection of the first line segment in right image frame 82R. Likewise, the pixel Lᵢ of the left display image is taken to be the intersection of the second line segment in left image frame 82L. This procedure automatically provides the appropriate amount of shifting and scaling to correctly render the visible surface, placing every locus i at the appropriate distance and with the appropriate perspective. In some examples, the approach outlined above may be facilitated by real-time estimation of the user's pupil positions. In examples in which pupil estimation is not attempted, a suitable surrogate for the pupil position, such as the center of rotation of the pupil position, or eyeball position, may be used instead.

Returning now to FIG. 2, controlling the stereo disparity of images confined to a focal plane is appropriate for rendering a three-dimensional effect, but it is less appropriate for shifting an entire display image back and forth in the user's field of view. To resolve depth in a complex scene, the human visual cortex interprets plural visual cues (e.g., occlusion and motion parallax), in addition to the neurologically coupled, oculomotor cues of binocular vergence and crystalline-lens accommodation. Stereo disparity correctly stimulates the binocular-vergence cue but does not stimulate the accommodation cue. Rather, the user's crystalline lenses remain focused on the fixed focal plane no matter the depth value indicated by the stereo disparity. When the disparity changes, but the focal plane does not move, a dissonance is perceived between the two oculomotor cues, which may result in user discomfort.

Accordingly, monocular system 18 of FIG. 2 may be configured to vary the focal plane on which virtual display imagery is presented. In the illustrated example, the monocular system includes a variable-focus lens 86 of variable optical power. Computer 12 is configured to control the focusing bias of the variable-focus lens such that the display light is imaged onto a focal plane positioned at a controlled, variable distance from pupil 28. In stereoscopic near-eye display devices, this control feature may be enacted in combination with appropriate control of the stereo disparity as described above. Monocular system 18 of FIG. 2 also includes a fixed-focus lens 88 in series with variable-focus lens 86 and arranged to pre-bias the vergence of the display light released from expansion optic 30.

Applied in an AR display system, variable-focus lens 86 and/or fixed-focus lens 88 would alter the vergence of the external light received from opposite the user. In FIG. 2, accordingly, monocular system 18 further comprises a variable-compensation lens 90 of variable optical power and a fixed compensation lens 92. In some examples, the fixed optical power of fixed-compensation lens 92 may oppose and substantially reverse the fixed optical power of fixed-focus lens 88. When controlling the focusing bias such that the display light is imaged onto a focal plane positioned at a controlled, variable distance from user O, computer 12 may also synchronously control the compensation bias of the variable compensation lens such that the external light reaches the user with unchanged vergence.

In conclusion, one aspect of this disclosure is directed to an optic comprising an optical waveguide, a series of anti-reflective laminae, and an exit grating. The optical waveguide has a surface and supports total internal reflection of display light from the surface. The series of anti-reflective laminae is formed on the optical waveguide, arranged parallel to the surface. The exit grating is formed on the series of anti-reflective laminae. The exit grating includes a two-dimensional matrix of replicated, nanometer-scale features distributed parallel to the surface.

In some implementations the series of anti-reflective laminae comprise layers of alternating refractive index, the layers of alternating refractive index comprise a first material of a first refractive index and a second material of a second refractive index, and the first refractive index is greater than the second refractive index at one or more wavelengths. In some implementations the first material comprises titania and the second material comprises silica. In some implementations the exit grating further comprises a bias layer of non-zero bias thickness, the nanometer-scale features are distributed on the bias layer, and the bias layer and the nanometer-scale features have equivalent refractive index. In some implementations the nanometer-scale features are distributed directly onto the series of anti-reflective lamina, with no intervening bias layer. In some implementations each of the nanometer-scale features comprises a recess feature and/or a protrusive feature. In some implementations each of the nanometer-scale features has a longest dimension and an axis aligned to the longest dimension, and the axes of each of the nanometer-scale features are oblique to the surface and mutually parallel. In some implementations a size, shape, axis orientation, and/or spatial period of the nanometer-scale features varies along and/or across the exit grating. In some implementations the exit grating comprises a patterned metagrating layer. In some implementations the patterned metagrating layer comprises a cured resin. In some implementations the optic further comprises an entry grating formed on the optical waveguide and configured to in-couple the display light into the optical waveguide, and the optic is a pupil-expansion optic.

Another aspect of this disclosure is directed to a method for making an optic. The method comprises (a) applying a series of anti-reflective laminae to an optical waveguide, parallel to a surface of the optical waveguide; and (b) distributing a two-dimensional matrix of replicated, nanometer-scale features on the series of anti-reflective laminae, parallel to a surface of the optical waveguide. The optical waveguide supports total internal reflection of display light from the surface, and the matrix of replicated, nanometer-scale features comprise an exit grating.

In some implementations applying the series of anti-reflective laminae comprises printing, atomic-layer deposition, chemical-vapor deposition, physical-vapor deposition, and/or spin coating. In some implementations distributing the two-dimensional matrix comprises printing curable material in a pattern corresponding to the replicated, nanometer-scale features; and curing the curable material. In some implementations distributing the two-dimensional matrix comprises: applying a coating to the optical waveguide; and selectively etching the coating in a pattern corresponding to the replicated, nanometer-scale features. In some implementations selectively etching the coating comprises: fabricating a hard mask; and etching the coating through the hard mask. In some implementations each of the nanometer-scale features comprises a recess feature and/or a protrusive feature.

Another aspect of this disclosure is directed to a near-eye display device comprising a display projector and an expansion optic configured to receive a display image from the display projector and to release an expanded form of the display image. The expansion optic comprises an optical waveguide having a surface and supporting total internal reflection of the display image from the surface; a series of anti-reflective laminae formed on the optical waveguide, arranged parallel to the surface; and an exit grating formed on the series of anti-reflective laminae. The exit grating includes a two-dimensional matrix of replicated, nanometer-scale features distributed parallel to the surface.

In some implementations the expansion optic further comprises an entry grating formed on the optical waveguide and configured to in-couple the display light into the optical waveguide. In some implementations the nanometer-scale features are distributed directly onto the series of anti-reflective lamina, with no intervening bias layer.

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An optic comprising:
an optical waveguide having a surface and supporting total internal reflection of display light from the surface;
a series of anti-reflective laminae formed on the optical waveguide, arranged parallel to the surface; and
an exit grating formed on the series of anti-reflective laminae, the exit grating including a two-dimensional matrix of replicated, nanometer-scale features distributed parallel to the surface.

2. The optic of claim 1 wherein the series of anti-reflective laminae comprise layers of alternating refractive index, wherein the layers of alternating refractive index comprise a first material of a first refractive index and a second material of a second refractive index, and wherein the first refractive index is greater than the second refractive index at one or more wavelengths.

3. The optic of claim 2 wherein the first material comprises titania and the second material comprises silica.

4. The optic of claim 1 wherein the exit grating further comprises a bias layer of non-zero bias thickness, wherein the nanometer-scale features are distributed on the bias layer, and wherein the bias layer and the nanometer-scale features have equivalent refractive index.

5. The optic of claim 1 wherein the nanometer-scale features are distributed directly onto the series of anti-reflective lamina, with no intervening bias layer.

6. The optic of claim 1 wherein each of the nanometer-scale features comprises a recess feature and/or a protrusive feature.

7. The optic of claim 1 wherein each of the nanometer-scale features has a longest dimension and an axis aligned to the longest dimension, and wherein the axes of each of the nanometer-scale features are oblique to the surface and mutually parallel.

8. The optic of claim 1 wherein a size, shape, axis orientation, and/or spatial period of the nanometer-scale features varies along and/or across the exit grating.

9. The optic of claim 1 wherein the exit grating comprises a patterned metagrating layer.

10. The optic of claim 1 wherein the patterned metagrating layer comprises a cured resin.

11. The optic of claim 1 further comprising an entry grating formed on the optical waveguide and configured to in-couple the display light into the optical waveguide, wherein the optic is a pupil-expansion optic.

12. A method for making an optic, the method comprising:
applying a series of anti-reflective laminae to an optical waveguide, parallel to a surface of the optical waveguide;
distributing a two-dimensional matrix of replicated, nanometer-scale features on the series of anti-reflective laminae, parallel to a surface of the optical waveguide,
wherein the optical waveguide supports total internal reflection of display light from the surface, and wherein the matrix of replicated, nanometer-scale features comprise an exit grating.

13. The method of claim 12 wherein applying the series of anti-reflective laminae comprises printing, atomic-layer deposition, chemical-vapor deposition, physical-vapor deposition, and/or spin coating.

14. The method of claim 12 wherein distributing the two-dimensional matrix comprises:
printing curable material in a pattern corresponding to the replicated, nanometer-scale features; and
curing the curable material.

15. The method of claim 12 wherein distributing the two-dimensional matrix comprises:
applying a coating to the optical waveguide; and
selectively etching the coating in a pattern corresponding to the replicated, nanometer-scale features.

16. The method of claim 12 wherein selectively etching the coating comprises:
fabricating a hard mask; and
etching the coating through the hard mask.

17. The method of claim 12 wherein each of the nanometer-scale features comprises a recess feature and/or a protrusive feature.

18. A near-eye display device comprising:
a display projector;
an expansion optic configured to receive a display image from the display projector and to release an expanded form of the display image, the expansion optic comprising:
an optical waveguide having a surface and supporting total internal reflection of the display image from the surface
a series of anti-reflective laminae formed on the optical waveguide, arranged parallel to the surface; and
an exit grating formed on the series of anti-reflective laminae, the exit grating including a two-dimensional matrix of replicated, nanometer-scale features distributed parallel to the surface.

19. The near-eye display device of claim 18 wherein the expansion optic further comprises an entry grating formed on the optical waveguide and configured to in-couple the display light into the optical waveguide.

20. The near-eye display device of claim 18 wherein the nanometer-scale features are distributed directly onto the series of anti-reflective lamina, with no intervening bias layer.
